(19) United States
(12) Patent Application Publication
(10) Pub. No.: US 2001/0047958 A1
(43) Pub. Date: Dec. 6, 2001

(54) Filter apparatus

(76) Inventor: John W. Estep, Newnan, GA (US)

Correspondence Address: GARDNER GROFF MEHRMAN & JOSEPHIC, P.C., PAPER MILL VILLAGE, BUILDING 23, 600 VILLAGE TRACE, SUITE 300, MARIETTA, GA, 30067, US

(21) Appl. No.: 09/863,936

(22) Filed: May 23, 2001

Related U.S. Application Data
(60) Provisional application No. 60/206,683, filed on May 24, 2000.

(51) Int. Cl. B01D 29/00

(52) U.S. Cl. 210/433.1; 210/435

(57) ABSTRACT

A tubular member is received coaxially within a tubular housing, has a plurality of lower and upper openings, and has a sealing flange between the top and the bottom ends of the hollow member. The flange cooperates with the housing to direct the wastewater to flow into the hollow member through the lower openings, while a portion of the solid waste matter is not permitted to flow through the lower openings, in a first filtration stage. The wastewater is then directed to flow upward and back out of the hollow member through the upper openings, while any remaining portion of the solid waste matter is not permitted to flow through the upper openings, in a second filtration stage.

### TECHNICAL FIELD

This invention relates to filters and, more particularly, to a filter for staged separation of solid waste matter from wastewater in septic tanks.

### BACKGROUND OF THE INVENTION

Septic tanks are commonly used to store and biodegrade solid human waste in wastewater. After the waste has biodegraded or otherwise been treated in the tank, the treated wastewater is released from the tank. Typical septic tanks have a filter for any residual waste matter and an outflow opening for releasing the treated water. However, known filters provide only a limited amount of filtration and are subject to frequent clogging. Accordingly, what is needed but not found in the prior art is a septic tank filter for separating solid waste matter from wastewater that provides for increased filtration and a reduced incident of clogging.

### SUMMARY OF THE INVENTION

The filter of the present invention overcomes the deficiencies of the prior art by providing a hollow member that is receivable within a housing and has a covered bottom and a top. The hollow member has a plurality of lower and upper openings formed therein and a sealing flange between the top and the bottom thereof so that the lower openings are disposed below the flange and the upper openings are disposed above the flange. The flange of the hollow member cooperates with the housing to direct the wastewater to flow into the hollow member through the lower openings, but not through the hollow member bottom, while a portion of the solid waste matter is not permitted to flow through the lower openings, in a first filtration stage. The wastewater is then directed to flow upward and back out of the hollow member through the upper openings, while any remaining portion of the solid waste matter is not permitted to flow through the upper openings, in a second filtration stage.

In an exemplary embodiment the filter is used with a housing that has an inner diameter, and the sealing flange has an outer diameter that is the same or slightly less than the inner diameter of the housing. Also, the hollow member has an outer diameter that is less than the inner diameter of the housing and less than the outer diameter of the sealing flange so that an annular passageway is formed between the hollow member and the housing through which the wastewater may flow. Additionally, the housing has an outlet and the flange is disposed on the hollow member so that it is below the housing oulet when the hollow member is inserted into the housing, so that the wastewater can flow out of the hollow member through the upper openings and then out of the housing through the outlet. Furthermore, the housing has a lip and the hollow member has an upper flange that engages the lip when the hollow member is inserted into the housing, so that the filter is supported in the housing.

In a first alternative embodiment, the filter includes at least one sheet of porous material lining the hollow member. Also, the hollow member extends through the bottom of the housing when the hollow member is inserted in the housing. In this form, the filter can produce greater filtration yet also be nade more economically.

In a second alternative embodiment, the filter has two sealing flanges and a barrier member within the housing between the two sealing flanges. Also, the lower openings and the upper openings have different sizes for producing the desired filtration characteristics. In this form, the wastewater can be filtered in as many stages as desired, with each stage with a selected filtration rate.

In view of the foregoing, it will be appreciated that present invention provides a filter that efficiently removes solid waste matter from wastewater. The openings and the sealing flange cooperate with the housing to provide a multi-stage filtration process that better filters solid waste matter from wastewater. Also, the closed bottom and side openings produce a filtration that permits the filtered solid matter to fall back down into the septic tank, thereby reducing the incidence of filter clogging. Furthermore, the filter can be manufactured economically in large quantities.

The specific techniques and structures employed by the invention to improve over the drawbacks of the prior systems and accomplish the advantages described above will become apparent from the following detailed description of the embodiments of the invention and the appended drawings and claims.

### BRIEF DESCRIPTION OF THE DRAWINGS

FIG. 1 is an elevation view of an exemplary embodiment of the present filter invention and a cross section view of a housing, showing the filter inserted into the housing for use.

FIG. 2 is a top plan view of the filter and the housing of FIG. 1.

FIG. 3 is a bottom plan view of the filter and the housing of FIG. 1.

FIG. 4 is a cross section view of a septic tank, showing the filter and the housing of FIG. 1 installed therein.

FIG. 5 is an elevation view of the filter of FIG. 1 without the housing.

FIG. 6 is an elevation view of the filter of FIG. 1 being inserted into the housing.

FIG. 7 is an elevation view of the filter of FIG. 1, showing the flow of fluid produced by the filter to achieve a two-stage filtration process.

FIG. 8 is an elevation view of a first alternative embodiment of the present filter invention, showing an intermediate flange that serves as a seal and a support for the filter in the housing.

FIG. 8A is a cutaway perspective view of the alternative filter of FIG. 8, showing porous sheets lining the hollow member.

FIG. 9 is an elevation view of a second alternative embodiment of the present filter invention, showing the flow of fluid produced by the filter to achieve a four-stage filtration process.

### DETAILED DESCRIPTION OF THE EXEMPLARY EMBODIMENTS

Referring to the drawing figures, FIGS. 1-4 show an exemplary embodiment the present invention, generally referred to as the filter 10. The filter 10 is used in conjunction with a housing 14, with the filter inserted into and supported by the housing for use. The housing 14 can be provided by a tube 7 having a lower inlet 11 and an upper outlet 13, with the upper outlet defined by a hollow member such as outlet tube 9 extending from the tube 7. The housing 14 can have an upper section 15, a lower section 17, and a transition section 19 disposed therebetween, with the upper section 15 having a greater inner diamater than the lower section 17, and the transition section 19 having a support lip 21 formed by a tapered or generally horizontal inner wall.

The housing 14 can be made economically by, for example, a conventional “T” or “L” joint and a length of pipe cemented together. In a typical commercial embodiment, the housing can be made of four-inch PVC pipe. Of course, other materials, components, assembly, and configurations can be suitably employed. For example, while the housing tube 7 is shown with a generally circular cross section (see FIGS. 2 and 3), alternatively, it can have a rectangular, polygonal, or other regular or irregular cross sectional shape, as may be desired to generally conform to or to differ from the cross sectional shape of the filter 10 in order to provide a particular fluid flow and filtration. Also, while the lower inlet 11 is shown in the bottom of the housing tube 7, alternatively, it can be formed in the side thereof, and while the upper outlet 13 is shown in the side of the housing, alternatively, it can be formed in the top thereof.

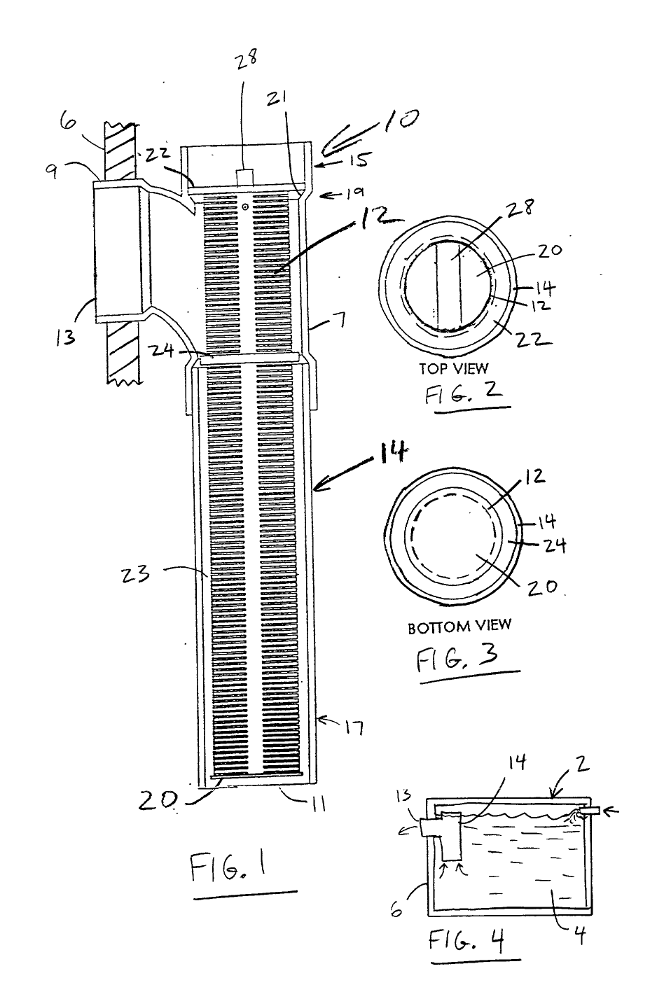

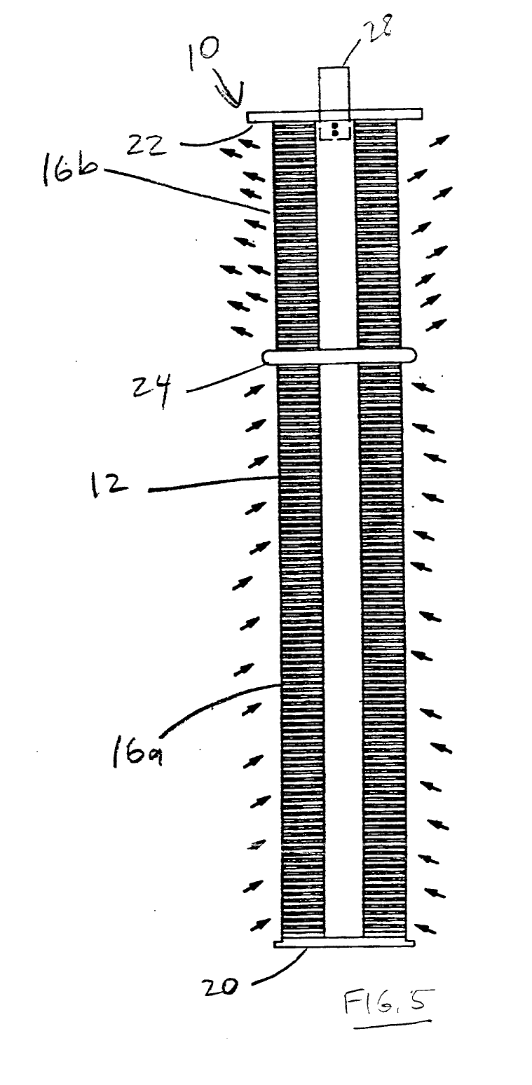

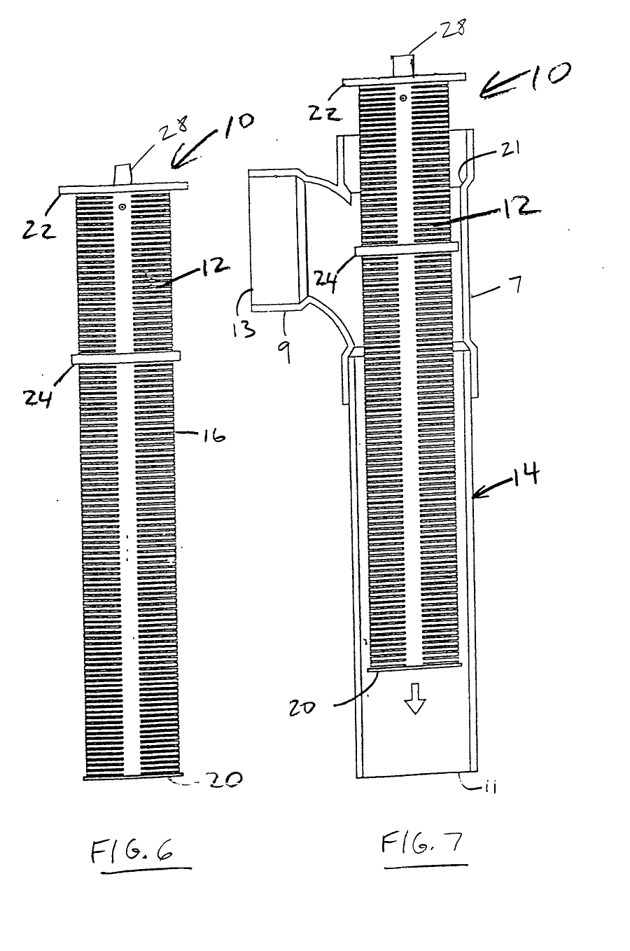

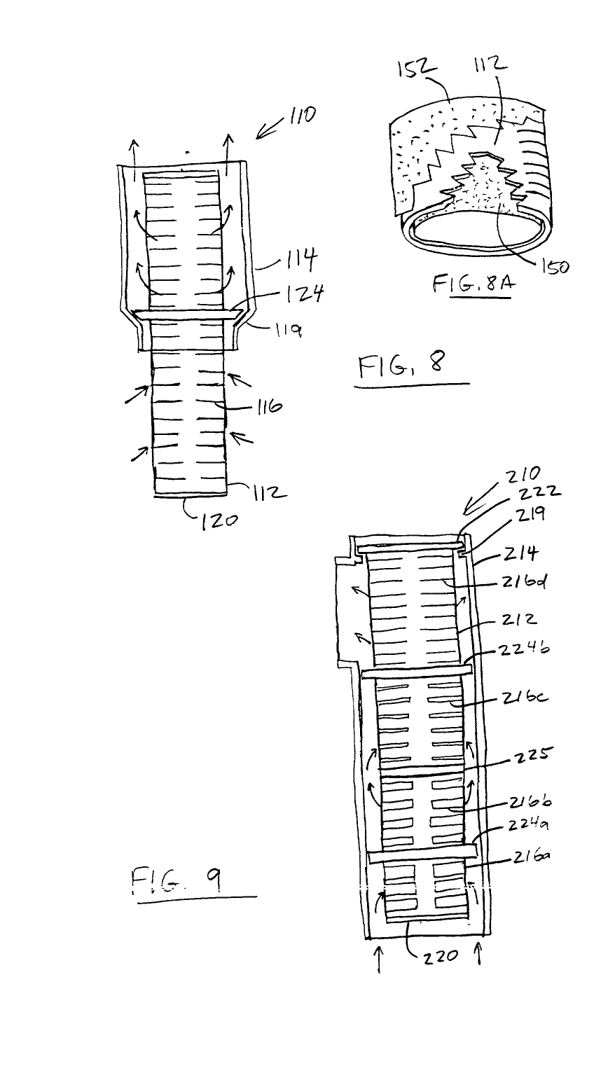

The housing 14 is installed in a septic tank 2 for use. Typical septic tanks 2 have walls 6 forming a chamber that holds wastewater 4. The outlet tube 9 of the housing can be extended through an opening in one of the walls 6 of the septic tank 2 (see FIG. 4). As the wastewater level rises in the septic tank 2 due to the input of wastewater for treatment, the water is directed through the filter 10, thereby removing most if not all of the suspended solid waste matter prior to releasing the water to the environment. It will be understood that the filter 10 can be used in other applications for separating other matter (not just human solid waste) from other fluids (not just wastewater), for example, in fuel, air, lubricant, coolant, refrigerant, water with other particle matter, steam, and other filtering applications.

Turning now to the details of the filter 10 itself, it comprises an elongated hollow member such as a tubular member 12, with an outer diameter sized to be received coaxially within the housing 14. In a typical commercial embodiment, the tubular member 12 can have an outer diameter of about three inches so it can be inserted into a four-inch diamter housing tube 7. The tubular member 12 can have a length so that it can be entirely enclosed within the housing 14 or so that a portion of the member 12 extends from the housing. The tubular member 12 can be made of PVC, plastic, fiberglass, metal, a composite, or another material. The tubular member 12 can have a generally circular cross section (see FIGS. 2 and 3), alternatively, it can have a rectangular, polygonal, or other regular or irregular cross sectional shape, as may be desired to generally conform to or to differ from the cross sectional shape of the housing tube 7 in order to provide a particular fluid flow and filtration.

The tubular member 12 has a plurality of openings 16 defined therein for filtering the solid matter from the wastewater. Accordingly, the openings 16 have a size sufficiently large to allow water to pass therethrough yet sufficiently small to prevent the solid waste matter from passing therethrough. In a typical commercial embodiment, the openings 16 are provided by generally vertically spaced horizontal slits, with the slits extending at least a portion of the way around the tubular member 12. For example, each slit can be generally semi-circular, extend a little less than about a third of the way around the tubular member 12, have a width of about 0.0625 inches, and be spaced about 0.325 inches apart.

Of course, the openings can have other shapes, sizes, and spacings selected to accomplish the desired filtration of solid waster or other matter. For example, the openings 16 can have a circular, elliptical, polygonal, rectangular, or other regular or irregular shape, or a combination thereof, the openings can be provided by perforations, vertical or diagonal slits, or other openings, and/or the openings can be provided by gaps where a portion of the tubular member is provided by a mesh screen or the like, pores where a portion of the tubular member is porous, or by other filtration structures known in the art.

The tubular member 12 has a bottom cover 20 that closes the bottom end of the tubular member such that the water and waste are prevented from entering the tubular member through the bottom. Alternatively, the bottom cover can be provided with one or more openings that are shaped, sized, and spaced simlarly to the openings described above for providing additional filtration. An upper support flange 22 extends generally horizontally from the tubular member 12 at an upper portion thereof, and an intermediate sealing flange 24 extends generally horizontally from the tubular member 12 at a position between the top end and the bottom end of the tubular member 12. A top cover can be provided for the top end of the tubular member 12, if desired. However, in many applications it is desirable to leave the top end open (and the housing top end open) for overflow protection so that if the filter bottom becomes clogged the wastewater can flow into the tubular member 12 from the top and still function to filter and release the wastewater.

The upper flange 22 is selected with an outer diameter that is greater than the inner diameter of the tube 7 at a portion of the transition section 19, so that the flange 22 rests on the lip 21 of the housing 14 to support the filter 10 therein. In this arrangement, the flange 22 and the lip 21 cooperate to act as a seal to prevent the wasterwater from exiting the housing through its top. Alternatively or additionally, the tubular member 12 can have one or more hooks, arms, curved rims, combination thereof, or other structures extending upwardly therefrom that hook onto the top edge of the housing and threby support the tubular member withint th housing.

The intermediate flange 24 is selected with an outer diameter that is the same or slightly less than the inner diameter of the tube 7 in order to form a seal between the flange 24 and the housing 14. Also, the intermediate flange 24 outer diameter is greater than the outer diameter of the tubular member 12, thereby forming an annular passageway 23 between the tubular member 12 and the housing tube 7 below the flange 24.

The upper 22 and intermediate flanges 24 and the bottom cover 20 may be made of PVC, rubber, plastic, fiberglass, metal, an elastomer, a composite, or another material known in the art, and may integrally formed with the tubular member 12 or may be attached thereto by a rivet, screw, adhesive, or other fastener. Also, the bottom cover 20 can be provided by a conventional PVC cap.

Referring to FIG. 5, the arrangement of the closed bottom 20 and the upper 22 and intermediate flanges 24 causes the upwardly flowing wastewater (shown by arrows) to flow through the passageway and into the tubular member 12 through the lower openings 16a in the lower portion of the tubular member 12 while the solid waste is filtered out by the lower openings 16a in a first filtration stage. The bottom cover 20 prevents the wastewater from entering the tubular member 12 through the bottom and bypassing the first filtration stage. The filtered solid matter then falls back down through the wastewater in the septic tank, thereby reducing the incident of clogging of the filter 10. The first stage filtered wastewater then flows back out of the tubular member 12 through the upper openings 16b while any residual solid waste is filtered out by the upper openings 16b in a second filtration stage. The filtered water then flows through the outlet 13 of the housing 14 and out of the septic tank. Accordingly, the wastewater is filtered twice by the present filter apparatus, providing for an increased filtration of the wastewater.

The intermediate flange 24 is disposed on the tubular member 7 so that, when the filter 10 is inserted within the housing 14, the flange 24 is positioned below the housing outlet 13. The position of the intermediate flange 24 on the tubular member 7 can be selected to provide the desired filtration for a particular application. For example, the intermediate flange 24 can be positioned so that the first filtration stage is accomplished by a first filtration area (below the intermediate flange 24) having a cumulative opening area of about 42.0 square inches, and the second filtration stage is accomplished by a second filtration area (above the intermediate flange 24) having a cumulative opening area of about 16.5 square inches. Of course, the flange 24 can be positioned elsewhere on the tubular member 12 to produce different cumulative opening areas and filtration characteristics, as may be desired.

Referring to FIG. 6, there is shown the filter 10 before insertion into the housing 14, for clarity. Referring to FIG. 7, a strap 28 made of PVC or another material may be attached to the tubular member 12, for example, at the top cover 18, for facilitating insertion (in the direction indicated by the arrow) and removal of the tubular member 12 from the housing 14. Alternatively, a bolt, pin, or the like made of nylon or another material can be extended across the top end through holes in the sidewalls of the tubular mamber 12, thereby providing a handle for gripping the tubular member.

Referring to FIG. 8, a first alternative embodiment of the present invention provides a filter 110 comprising an elongated hollow member such as tubular member 112 with a top end and a bottom end, a bottom cover 120, openings 116 defined in the tubular member 112, and an intermediate sealing flange 124 disposed between the top end and the bottom end, with the filter 110 inserted into a housing 114 with a lip 119, all similar to the exemplary embodiment. In this embodiment, the flange 124 seals and also supports the filter 110 in the housing 114, so that the upper flange of the first embodiment is not required. Also, the flange 124 can have tapered outer edges to generally conform to a tapered surface of the lip 119, to provide a good seal. Additionally, the housing 114 can be provided by a conventional reducer pipe section (with the housing outlet in the top thereof), and the tubular member 112 can extend out of the housing, so that the housing can be economically produced. Accordingly, the upwardly flowing wastewater (shown by arrows) is filtered in a two-stage filtration process, similar to that provided by the first embodiment.

Furthermore, FIG. 8A shows another stage of filtration provided by a sheet of a generally porous material lining the inside and/or outside of the tubular member 112 for providing alternative or additional filtration of the wastewater. For example, an inner sheet 150 and an outer sheet 152 made a fabric, mesh, screen, or another generally porous material can be provided.

Referring to FIG. 9, a second alternative embodiment of the present invention provides a filter 210 comprising an elongated hollow member such as tubular member 212 with a top end and a bottom end, a bottom cover 220, openings 216a-216d defined in the tubular member 212, and intermediate sealing flanges 224a and 224b disposed between the top end and the bottom end, with the filter 210 inserted into a housing 214, all similar to the exemplary embodiment. In this embodiment, two flanges 224a and 224b are provided instead of one, and a barrier member 225 is provided within the tubular member 212 between the flanges 224a and 224b that blocks water flow through the tubular member. Accordingly, the upwardly flowing wastewater (shown by arrows) is filtered in a four-stage filtration process, similar to that provided by the first embodiment. Of course, any number of flanges and barriers can be provided to produce the number of filtration stages desired. Also, the openings 16a-16d can have different sizes, so that the filtration is staged, for example, with larger openings lower on the tubular member 212 for first filtering larger matter and relatively smaller openings higher on the tubular member for then filtering the remaining matter in the water.

Furthermore, this embodiment demonstrates another support structure for the filter within the housing, with the housing lower and upper sections having generally the same inner diameter, the lip 219 formed by a inwardly extending flange or the like, and the flange 222 resting upon the lip 219. Alternatively, the lip can be formed by the top edge of the housing. Of course, other filter support structures can be suitably employed to function with the multi-stage filter and housing without detracting from the benefits provided thereby.

In view of the foregoing, it will be appreciated that present invention provides a filter that efficiently removes solid matter from wastewater. The filter provides a multi-stage filtration process that better filters solid waste matter from wastewater. Also, the closed bottom and side openings produce a filtration that permits the filtered solid matter to fall back down into the septic tank, thereby reducing the incidence of filter clogging. Furthermore, the filter can be manufactured economically in large quantities.

In the embodiments described above and the following claims, the words “a” and “an” are not intended to mean only “one” but can also mean any number greater than one. While certain embodiments are described above with particularity, these should not be construed as limitations on the scope of the invention. It should be understood, therefore, that the foregoing relates only to exemplary embodiments of the present invention, and that numerous changes may be made therein without departing from the spirit and scope of the invention as defined by the following claims.

The invention claimed is:

1. A filter for separating fluid and solid matter suspended therein, the filter receivable within a housing, the filter comprising:
a) a hollow member having a bottom end with a cover and a top end, the hollow member receivable within the housing;
b) a plurality of lower and upper openings formed in the hollow member; and
c) at least one sealing flange extending from the hollow member and disposed thereon at a position between the top end and the bottom end thereof such that the lower openings are disposed below the flange and the upper openings are disposed above the flange,
wherein the fluid is permitted to flow into the hollow member through the lower openings, while a portion of the solid matter is not permitted to flow through the lower openings, and the fluid is then permitted to flow upward and back out of the hollow member through the upper openings while any remaining portion of the solid matter is not permitted to flow through the upper openings.

2. The filter of claim 1, wherein the housing has an inner diameter, and wherein the sealing flange has an outer diameter that is the same or slightly less than the inner diameter of the housing.

3. The filter of claim 2, wherein the hollow member has an outer diameter that is less than the inner diameter of the housing and less than the outer diameter of the sealing flange so that a passageway is formed between the hollow member and the housing through which the fluid may flow.

4. The filter of claim 1, wherein the housing has an outlet, and wherein the flange is disposed on the hollow member so that the flange is below the housing oulet when the hollow member is inserted into the housing, and wherein the upper openings are defined in the hollow member so that the fluid can flow out of the hollow member through the upper openings and then out of the housing through the outlet.

5. The filter of claim 4, wherein the housing has a lip, and further comprising an upper flange extending from the hollow member and engaging the lip when the hollow member is inserted into the housing so that the filter is supported in the housing.

6. The filter of claim 4, wherein the sealing flange and the lip have oppositely tapered outer edges, and the sealing flange engages the lip when the hollow member is inserted into the housing so that the filter is supported in the housing.

7. A filter for separating fluid and solid matter suspended therein, the filter receivable within a housing having an inner diameter, an inlet, an outlet, and a lip, the filter comprising:
a) a hollow member having a bottom end with a cover, a top end, an upper flange extending from the hollow member at or adjacent the top end, and an outer diameter, wherein the upper flange engages the housing lip when the hollow member is inserted into the housing so that the filter is supported in the housing;
b) a plurality of lower and upper openings defined in the hollow member; and
c) at least one sealing flange extending from the hollow member, having an outer diameter that is the same or slightly less than the inner diameter of the housing, disposed thereon at a position between the top end and the bottom end thereof such that the lower openings are disposed below the flange and the upper openings are disposed above the flange, and further disposed thereon so that the flange is below the housing oulet when the hollow member is inserted into the housing, wherein the outer diameter of the hollow member is less than the inner diameter of the housing and less than the outer diameter of the sealing flange so that a passageway is formed between the hollow member and the housing through which the fluid may flow,
wherein the fluid is permitted to flow through the housing inlet, through the passageway, and then into the hollow member through the lower openings, but not through the bottom, while a portion of the solid matter is not permitted to flow through the lower openings, and the fluid is then permitted to flow upward and back out of the hollow member through the upper openings while any remaining portion of the solid matter is not permitted to flow through the upper openings.

8. The filter of claim 7, further comprising at least one sheet of porous material lining the hollow member.

9. The filter of claim 7, wherein the hollow member extends through the bottom of the housing when the hollow member is inserted in the housing.

10. The filter of claim 7, wherein the lower openings and the upper openings have different sizes.

11. The filter of claim 7, wherein the at least one sealing flange comprises two sealing flanges, and further comprising a barrier member disposed within the housing between the two sealing flanges.

12. The filter of claim 7, wherein the hollow member comprises a tube made of PVC.

13. A filter assembly for separating fluid and solid matter suspended therein, comprising:
a) a housing having an inlet and an outlet;
b) a hollow member receivable with in the housing, the hollow member having a bottom end with a cover and a top end;
c) a plurality of lower and upper openings formed in the hollow member; and
d) at least one sealing flange extending from the hollow member and disposed thereon at a position between the top end and the bottom end thereof such that the lower openings are disposed below the flange and the upper openings are disposed above the flange,
wherein the fluid is permitted to flow into the housing inlet then into the hollow member through the lower openings, while a portion of the solid matter is not permitted to flow through the lower openings, and the fluid is then permitted to flow upward and back out of the hollow member through the upper openings then out of the housing through the housing outlet, while any remaining portion of the solid matter is not permitted to flow through the upper openings.

14. The filter of claim 13, wherein the housing has an inner diameter and the sealing flange has an outer diameter that is the same or slightly less than the inner diameter of the housing.

15. The filter of claim 14, wherein the hollow member has an outer diameter that is less than the inner diameter of the housing and less than the outer diameter of the sealing flange so that a passageway is formed between the hollow member and the housing through which the fluid may flow.

16. The filter of claim 13, and wherein the flange is disposed on the hollow member so that the flange is below the housing oulet when the hollow member is inserted into the housing, and wherein the upper openings are defined in the hollow member so that the fluid can flow out of the hollow member through the upper openings and then out of the housing through the outlet.

17. The filter of claim 16, wherein the housing has a lip, and further comprising an upper flange extending from the hollow member and engaging the lip when the hollow member is inserted into the housing so that the filter is supported in the housing.

18. The filter of claim 13, wherein the lower openings and the upper openings have different sizes.

19. The filter of claim 13, wherein the housing outlet is formed by a hollow outlet member extending from the housing, and the outlet member is adapted to be connected to a septic tank.

20. The filter of claim 13, wherein the hollow member and the housing each comprise a tube made of PVC.
